(19) United States
(12) Patent Application Publication
(10) Pub. No.: US 2003/0035954 A1
(43) Pub. Date: Feb. 20, 2003

(54) Synthetic fiber improved in slimness and method for producing the same

(76) Inventors: Masaaki Miyoshi, Hyogo (JP); Satoru Harada, Hyogo (JP)

Correspondence Address: Brinks Hofer Gilson & Lione, P O Box 10395, Chicago, IL, 60611, US

(21) Appl. No.: 10/220,557

(22) PCT Filed: Feb. 21, 2001
(86) PCT No.: PCT/JP01/01280

(30) Foreign Application Priority Data
Feb. 29, 2000 (JP) 2000-53319

(51) Int. Cl. D04H 1/00; D02G 3/00; B32B 9/00

(52) U.S. Cl. 428/391; 428/365; 428/375; 428/378; 428/392; 428/394

(57) ABSTRACT

The present invention provides a synthetic fiber to be used for pile products having an appearance and texture near to natural fur, to which a softening agent is adhered, the fiber being obtainable by controlling the adhered amount of an emulsifier to 8 parts by weight or less relative to 100 parts by weight of a softening compound in the softening agent adhered to the synthetic fiber, and the fiber overcoming an insufficient slimy feeling and having a further lowered μs (F/F) and an improved sliminess. The invention also provides a process for producing the same.

### FIELD OF THE INVENTION

The present invention relates to a synthetic fiber having durability and also an improved sliminess. More specifically, it relates to a synthetic fiber having an improved sliminess wherein the adherence of an emulsifier to the synthetic fiber is reduced to a small amount and a process for producing the same.

### BACKGROUND OF THE INVENTION

In recent years, pile products having an appearance and texture near to natural fur skin have been made of synthetic fibers, but in general, synthetic fibers are insufficient in so-called slimy feeling (soft and smooth texture) in view of the texture as compared with natural animal hairs. For overcoming the disadvantage, various methods have been hitherto attempted.

Heretofore, for the purpose of improving the texture to animal hair-like one by smoothening the surface of a synthetic fiber, it is well known to use a silicone such as an organopolysiloxane as a treating agent. For example, Japanese Patent Publication No. 17514/1973 discloses a treatment with a combination of an amino-modified silicone and a polyepoxide, a combination of an epoxy-modified silicone and an amine compound, and a combination of an epoxy-modified silicone and an amino-modified silicone. Furthermore, since then, improved methods and treating agents based on the above method have been disclosed in Japanese Patent Publication Nos. 37996/1976, 19715/1978, and 19716/1978.

However, even by the above conventional methods, a sufficient animal hair-like texture is not attained. It is considered that this is because the lower limit of static friction coefficient between fibers (hereinafter, abbreviated as μs[F/F]) is 0.20 even when tried to lower.

Accordingly, it is an object of the invention to provide a synthetic fiber having an improved sliminess, which overcomes an insufficient slimy feeling and has a further lowered μs[F/F].

### DISCLOSURE OF THE INVENTION

As a result of the intensive studies for achieving the above object, the present inventors have found that an emulsifier adhered to a fiber largely influences μs[F/F]. That is, they have found that the decrease of the adhered amount of the emulsifier results in the decrease of μs[F/F] and the improvement of sliminess, and thus have reached the invention. Namely, the synthetic fiber of the invention is a synthetic fiber to which a softening agent is adhered, wherein the adhered amount of an emulsifier is 8 parts by weight or less relative to 100 parts by weight of a softening compound in the softening agent adhered to the synthetic fiber.

For realizing sliminess, it is preferred that the above softening agent is an emulsion of an organopolysiloxane and the softening compound is an organopolysiloxane. Moreover, the adhered amount of the organopolysiloxane is preferably from 0.1 to 5 parts by weight relative to 100 parts by weight of the synthetic fiber.

On the other hand, the process for producing a synthetic fiber according to the invention is a process for producing a synthetic fiber, which comprises, adhering a softening agent to the synthetic fiber such that an emulsifier is adhered to the synthetic fiber 8 parts by weight or less based on 100 parts by weight of a softening compound in the softening agent adhered to the synthetic fiber.

It is preferred that the above softening agent is an emulsion of an organopolysiloxane and the softening compound is an organopolysiloxane.

In a further preferred embodiment, a synthetic fiber is dipped in an aqueous solution containing a softening agent, and is treated at 40 to 100° C. for 5 to 30 minutes, and thereby the adhered amount of an emulsifier can be controlled to 8 parts by weight or less relative to 100 parts by weight of a softening compound in the softening agent adhered to the synthetic fiber.

The softening agent according to the invention means an emulsion containing a softening compound, and specifically, an emulsion of an organopolysiloxane, an emulsion of an amide derivative, and the like may be mentioned. Among these, preferred is an organopolysiloxane emulsion in view of the improvement of sliminess.

As the organopolysiloxane in the organopolysiloxane emulsion, at least one selected from dimethylpolysiloxane, amino-modified silicones, epoxy-modified silicones, and carboxy-modified silicones can be used. But in view of sliminess, amino-modified silicones are superior.

As the emulsifier according to the invention, in view of liquid stability of emulsion, a nonionic surfactant is generally used, and specific examples thereof include polyoxyethylene alkyl ethers such as polyoxyethylene dodecyl ether and polyoxyethylene tridecyl ether.

Since the emulsifier is important in view of emulsion stability, it is mixed in a softening agent in most cases, and the influence of the emulsifier on a fiber is hitherto rarely examined. As a result of the examination of the adhered amount and adhering method of a softening agent for the purpose of improving sliminess, the present inventors have surprisingly found that the emulsifier is an important factor of controlling sliminess.

Namely, the adhered amount of an emulsifier to a synthetic fiber is preferably 8 parts by weight or less, more preferably 6 parts by weight or less based on 100 parts by weight of a softening compound in the softening agent adhered. The above emulsifier means not only the emulsifier contained in the softening agent but also other emulsifier adhered to the fiber.

In the case of an emulsion of an organopolysiloxane which is preferred as a softening agent, the amount of the organopolysiloxane is preferably from 0.1 to 5 parts by weight, more preferably 0.2 to 3.0 parts by weight based on 100 parts by weight of the synthetic fiber from the standpoint of sliminess. In this case, the adhered amount of an emulsifier is preferably 8 parts by weight or less based on 100 parts by weight of the adhered amount of the organopolysiloxane.

In the invention, the following method may be mentioned for the purpose of controlling the adhered amount of the emulsifier to 8 parts by weight or less based on 100 parts by weight of a softening compound in the softening agent adhered to the synthetic fiber. For example, in the case of an organopolysiloxane, there may be mentioned a method of controlling the amount of an emulsifier finally adhered to a synthetic fiber to a determined amount by using an organopolysiloxane emulsion as an oily agent for spinning to be adhered at the production step of the synthetic fiber and by decreasing the content of the emulsifier in the emulsion beforehand.

As another method, a method of adhering an oily agent to a synthetic fiber by dipping a staple fiber of the synthetic fiber in an aqueous solution of, for example, an organopolysiloxane emulsion and by treating the aqueous solution at a temperature of 40 to 100° C. for 10 minutes, can be used.

In the latter method, it is presumed that the organopolysiloxane emulsion is destroyed with the elevation of temperature, the organopolysiloxane is adhered mainly to the fiber, most of the emulsifier remains in the aqueous solution, and, as a result, the amount of emulsifier adhered to the synthetic fiber can be reduced.

By the way, in all the above cases, when an organopolysiloxane is used, it is preferred to use an emulsion emulsified in water using an emulsifier. Moreover, when it is adhered at the production step of a synthetic fiber, an emulsion aqueous solution containing 8 parts by weight or less of an emulsifier based on 100 parts by weight of the organopolysiloxane is preferably used.

In the case of adhering it at the production step of a synthetic fiber, in a wet spinning, it may be adhered to the fiber in a wet state before drying, or may be adhered before crimping. In other dry spinning or melt spinning, there is no particular limitation.

On the other hand, the adhering method to a staple fiber, preferred is a method of treating in a batch process, and use of an Overmayer dyeing machine or the like may be exemplified.

The following will illustrate the case of using an organopolysiloxane emulsion as an example of an adhering method of a softening agent using an Overmayer dyeing machine. First, a staple fiber to be treated is charged into an Overmayer dyeing machine, and an organopolysiloxane emulsion may be charged and dissolved after the machine was filled with water or an aqueous solution of the organopolysiloxane emulsion may be charged directly into the dyeing machine. In this case, the concentration of the organopolysiloxane emulsion can be optionally selected depending on the aimed amount to be adhered.

Next, the whole was preferably heated to 40 to 100° C. at any rate and treated for about 10 minutes. By the way, the above treatment may be also conducted with a newly prepared aqueous solution of a softening agent after the fiber is dyed with a dye in an ordinary manner and then the dyeing solution is once removed.

The ratio of the emulsifier to the organopolysiloxane in the organopolysiloxane emulsion to be used in the above treatment is preferably 30 parts by weight or less of the emulsifier based on 100 parts by weight of the organopolysiloxane. The reasons are to hasten the destruction of the emulsion and to make the treatment easy.

The reason why the emulsifiers exert an influence on sliminess is not clear but, since some of polyoxyethylene alkyl ethers used as emulsifiers have an effect of imparting a creaky feeling to a fiber, it is presumed that they may lower sliminess.

The synthetic fibers to be subjects of the invention are not particularly limited but use are preferably made of fibers each having an excellent animal hair-like texture when they are converted into products such as boa and high pile. Among these, preferred are acrylic fibers, acryl-type fibers, and polyester fibers.

In view of an animal hair texture, the fineness of the synthetic fiber is preferably from 0.5 to 40 decitex (hereinafter, abbreviated as dtex), more preferably 2 to 30 dtex.

Furthermore, in the invention, use can be made of common additives such as a delustrant, a whiteness improver, an ultraviolet absorber, an organic or inorganic pigment, a dye, and the like, which are commonly used in the synthetic fibers. However, for enhancing an animal hair-like texture, the surface roughness of the fiber is preferably not so large. By the way, the cross-sectional shape is not particularly limited but is preferably a cross-sectional shape which does not increase the surface roughness.

### BEST MODE FOR CARRYING OUT THE INVENTION

The following will explain the present invention in further detail with reference to Examples, but the invention is not limited to these Examples. By the way, prior to the description of Examples, various analytical and evaluation methods will be explained.

(Quantitative Determination of Adhered Amount of Organopolysiloxane)

The adhered amount of an organopolysiloxane was determined by quantitatively determining the amount of Si element according to fluorescent X-ray analysis and calculating the adhered amount based on a calibration curve. Specifically, the calibration curve is prepared by measuring samples having known contents under conditions of a Rh tube (50 mA-50 kV), a measuring area of 30 mmφ, an analyzing crystal of PET, and a 2θ angle of 106 to 112 using a fluorescent X-ray analyzer of RIX3100 manufactured by Rigaku. Then, 2 g of a sample was subjected to press-molding by pressing at a room temperature and the adhered amount was calculated according to the following equation.

Adhered amount of organopolysiloxane=0.000135×(Si detection count−230)

The adhered amount of an organopolysiloxane was determined by quantitatively determining the amount of Si element according to fluorescent X-ray analysis and calculating the adhered amount based on a calibration curve.

(Adhered Amount of Emulsifier)

The adhered amount of an emulsifier was determined according to JIS K0101-1991 23.2 nonionic surfactant 23.2.1 tetrathiocyanocobalt(divaent) acid absorptiometry after a synthetic fiber was dipped in pure water, treated in an ultrasonic washing machine for 45 minutes, and then kept for 4 hours and allowed to stand to extract the emulsifier.

Specifically, a sample fiber was dipped in distilled water, treated in an ultrasonic washing machine of B2200 manufactured by BRANSON for 45 minutes, and then allowed to stand for 4 hours. Thereafter, the sample fiber was taken out, and the remaining liquid was subjected to a quantitative determination on UV-1600 manufactured by Shimadzu Corporation according to the above acid absorptiometry (quantitative determination mode 322 nm, a multi-point calibration curve method, a square cell having a light path length of 10 mm, and the range of absorbance<1.0 Abs).

(Evaluation of Animal Hair-Like Texture)

Using a sample synthetic fiber, a high pile having a product weight of pile fabric of 650 g/m² and a pile length of 13 mm was prepared. Then, texture of the pile surface (evaluation of sliminess) was evaluated by sensory analysis. The evaluation standard was as follows.

[4] It is extremely similar to animal hair and very much slimy.

[3] It is well similar to animal hair and slimy.

[2] It is similar to animal hair but has a slightly inferior sliminess.

[1] It has an inferior sliminess.

(Friction Coefficient between Fibers (μs(F/F))

The coefficient was measured according to Roder method (a fiber friction coefficient measuring machine).

Specifically, by a Roder method fiber friction coefficient measuring machine manufactured by Aoi Seiki Kenkyusho, sample fibers were aligned and fixed in a cylinder and then each of a 100 mg weight was attached to both ends of one other sample fiber, which was suspended on the cylinder. Thereafter, one of the weight was lifted up and the force at the time when the fiber began to slip was measured.

On each sample, data (n=20) were taken and the friction coefficient was calculated according to the equation of log(100/(100−m))=1.364 μs(F/F) (m is a force (mg) for lifting up until the fiber begins to slip).

(Viscosity of Emulsion)

The viscosity was measured under conditions of 30 rpm and a temperature of 25° C. using No. 2 rotor of a single drum rotating viscosimeter, model VS-A1 manufactured by Shibaura System, a sample emulsion being placed in a 1L volume beaker.

### EXAMPLE 1

A copolymer comprising 49.5 parts by weight of acrylonitrile, 50 parts by weight of vinyl chloride, and 0.5 part by weight of sodium styrenesulfonate was dissolved in acetone and the solution was subjected to wet spinning to obtain an acryl-type synthetic fiber (average fineness of staple fiber: 3dtex, cut length: 38 mm, cross-sectional shape: cocoon shape), 1000 g of which was weighed out and charged into an Overmayer dyeing machine (volume: 30 L).

Then, the Overmayer dyeing machine was filled with water (20 L), and 5 g of an emulsion of an organopolysiloxane having amino group (amine equivalent of the organopolysiloxane: 2000 g/mol, viscosity: 500 mPa·s, using 11 parts by weight of polyoxyethylene dodecyl ether as an emulsifier relative to 100 parts by weight of the organopolysiloxane) was dissolved therein to form an aqueous solution having an emulsion concentration of 0.00025% by weight.

The temperature was elevated at the rate of 4° C. per minute to 100° C. and the fiber was treated for 10 minutes. Thereafter, the whole was cooled at the rate of 3° C. per minute to 60° C., and successively cooled at the rate of 10° C. per minute to 30° C. Then, the treated synthetic fiber was taken out, centrifuged, and dried at 40° C. for 60 minutes using a holding hot-air dryer.

The adhered amount of the organopolysiloxane relative to 100 parts by weight of the resulting staple fiber was found to be 0.42 part by weight, the adhered amount of the emulsifier 0.026 part by weight, and μs (F/F) 0.11.

### EXAMPLE 2

The same copolymer as described in Example 1 was dissolved in acetone and, at wet spinning, 0.5% by weight of an emulsion of an organopolysiloxane having amino group (amine equivalent of the organopolysiloxane: 2000 g/mol, viscosity: 500 mPa·s, using 3 parts by weight of polyoxyethylene dodecyl ether as an emulsifier relative to the organopolysiloxane) was adhered to the swollen fiber after washing with water. The fiber was subjected to drying, thermal elongation, and thermal treatment according to a known method to obtain an acryl-type staple fiber (average fineness of staple fiber: 3dtex, cut length: 38 mm, cross-sectional shape: cocoon shape).

The adhered amount of the organopolysiloxane relative to 100 parts by weight of the fiber thus prepared was found to be 0.48 part by weight, the adhered amount of the emulsifier 0.015 part by weight, and μs (F/F) 0.13.

### EXAMPLE 3

A polyester staple fiber (P888 manufactured by Kuraray Co. Ltd., average fineness: 6dtex, cut length: 32 mm) was charged into an Overmayer, and treated in the same manner as Example 1. The adhered amount of the organopolysiloxane relative to 100 parts by weight of the fiber thus prepared was found to be 0.43 part by weight, the adhered amount of the emulsifier 0.020 part by weight, and μs (F/F) 0.10.

### EXAMPLE 4

A staple of an acryl-type synthetic fiber was charged into an Overmayer, and treated in the same manner as Example 1 with the exception that the amount of the oily agent to be added was 5% by weight. The adhered amount of the organopolysiloxane relative to 100 parts by weight of the fiber thus prepared was found to be 4.4 part by weight, the adhered amount of the emulsifier 0.026 part by weight, and μs (F/F) 0.10.

### EXAMPLE 5

A staple of an acryl-type synthetic fiber was charged into an Overmayer, and treated in the same manner as Example 1 with the exception that the amount of the oily agent to be added was 3% by weight. The adhered amount of the organopolysiloxane relative to 100 parts by weight of the fiber thus prepared was found to be 2.6 part by weight, the adhered amount of the emulsifier 0.016 part by weight, and μs (F/F) 0.09.

### EXAMPLE 6

A staple of an acryl-type synthetic fiber was charged into an Overmayer, and treated in the same manner as Example 1 with the exception that the amount of the oily agent to be added was 0.2% by weight. The adhered amount of the organopolysiloxane relative to 100 parts by weight of the fiber thus prepared was found to be 0.17 part by weight, the adhered amount of the emulsifier 0.013 part by weight, and μs (F/F) 0.15.

### EXAMPLE 7

A staple of an acryl-type synthetic fiber was charged into an Overmayer, and treated in the same manner as Example 1 with the exception that the amount of the oily agent to be added was 0.15% by weight. The adhered amount of the organopolysiloxane relative to 100 parts by weight of the fiber thus prepared was found to be 0.13 part by weight, the adhered amount of the emulsifier 0.010 part by weight, and μs (F/F) 0.17.

### COMPARATIVE EXAMPLE 1

The same copolymer as described in Example 1 was dissolved in acetone and, at wet spinning, 0.6 part by weight (relative to 100 parts by weight of the fiber) of an emulsion of an organopolysiloxane having amino group (amine equivalent of the organopolysiloxane: 2000 g/mol, viscosity: 500 mPa·s, using 11 parts by weight of polyoxyethylene dodecyl ether as an emulsifier relative to 100 parts by weight of the organopolysiloxane) was adhered to the swollen fiber after washing with water to obtain a staple fiber (average fineness of staple fiber: 3dtex, cut length: 38 mm, cross-sectional shape: cocoon shape).

The adhered amount of the organopolysiloxane relative to 100 parts by weight of the fiber thus prepared was found to be 0.53 part by weight, the adhered amount of the emulsifier 0.06 part by weight, and μs (F/F) 0.19.

### COMPARATIVE EXAMPLE 2

The same copolymer as described in Example 1 was dissolved in acetone and, at wet spinning, 0.7 part by weight (relative to 100 parts by weight of the fiber) of an emulsion of an organopolysiloxane having amino group (amine equivalent of the organopolysiloxane: 2000 g/mol, viscosity: 500 mPa·s, using 30 parts by weight of polyoxyethylene dodecyl ether as an emulsifier relative to the organopolysiloxane) was adhered to the swollen fiber after washing with water to obtain a staple fiber (average fineness of staple fiber: 3dtex, cut length: 38 mm, cross-sectional shape: cocoon shape).

The adhered amount of the organopolysiloxane relative to 100 parts by weight of the fiber thus prepared was found to be 0.53 part by weight, the adhered amount of the emulsifier 0.16 part by weight, and μs (F/F) 0.19.

### COMPARATIVE EXAMPLE 3

The same copolymer as described in Example 1 was dissolved in acetone and, at wet spinning, 0.8 part by weight (relative to 100 parts by weight of the fiber) of an emulsion of an organopolysiloxane having amino group (amine equivalent of the organopolysiloxane: 2000 g/mol, viscosity: 500 mPa·s, using 60 parts by weight of polyoxyethylene dodecyl ether as an emulsifier relative to the organopolysiloxane) was adhered to the swollen fiber after washing with water to obtain a staple fiber (average fineness of staple fiber: 3dtex, cut length: 38 mm, cross-sectional shape: cocoon shape).

The adhered amount of the organopolysiloxane relative to 100 parts by weight of the fiber thus prepared was found to be 0.50 part by weight, the adhered amount of the emulsifier 0.30 part by weight, and μs (F/F) 0.22.

Table 1 shows the evaluation data obtained in Examples and Comparative Examples.

TABLE 1

| | | | | Static | |
|---|---|---|---|---|---|
| | Adhered amount | Adhered | Adhered amount of | friction | |
| | of organo- | amount of | emulsifier relative | coefficient | |
| | polysiloxane | emulsifier | to 100 parts by | between | Rank |
| | (part by | (part by | weight of softening | fibers | of |
| | weight) | weight) | agent (part by weight) | (μa [F/F]) | texture |
| Example 1 | 0.42 | 0.026 | 6.2 | 0.11 | 4 |
| Example 2 | 0.48 | 0.015 | 3.1 | 0.13 | 4 |
| Example 3 | 0.43 | 0.020 | 4.7 | 0.10 | 4 |
| Example 4 | 4.40 | 0.026 | 0.6 | 0.10 | 4 |
| Example 5 | 2.60 | 0.016 | 0.6 | 0.09 | 4 |
| Example 6 | 0.17 | 0.013 | 7.6 | 0.15 | 3 |
| Example 7 | 0.13 | 0.010 | 7.7 | 0.17 | 3 |
| Comparative | 0.53 | 0.060 | 11.3 | 0.19 | 2 |
| Example 1 | | | | | |
| Comparative | 0.53 | 0.16 | 30.2 | 0.19 | 2 |
| Example 2 | | | | | |
| Comparative | 0.50 | 0.30 | 60.0 | 0.22 | 1 |
| Example 3 | | | | | |

### INDUSTRIAL APPLICABILITY

The synthetic fiber according to the invention has a lowered μs[F/F] by reducing the adhered amount of an emulsifier to a small amount (preferably 8 parts by weight or less relative to 100 parts by weight of the adhered amount of an organopolysiloxane), and thereby a fiber having an enhanced sliminess as compared with conventional fibers and an animal hair-like texture can be obtained. The fiber can exhibit a maximum effect in pile products such as boa and high pile.

1. A synthetic fiber to which a softening agent is adhered, wherein an emulsifier is adhered to the synthetic fiber in an amount of 8 parts by weight or less based on 100 parts by weight of a softening compound in the softening agent adhered to the synthetic fiber.

2. The synthetic fiber according to claim 1, wherein the softening agent is an emulsion of an organopolysiloxane and the softening compound is an organopolysiloxane.

3. The synthetic fiber according to claim 2, wherein the adhered amount of the organopolysiloxane is from 0.1 to 5 parts by weight relative to 100 parts by weight of the synthetic fiber.

4. The synthetic fiber according to any one of claims 1 to 3, which has a static friction coefficient between fibers (μs (F/F)) of 0.18 or less.

5. A process for producing a synthetic fiber, which comprises adhering a softening agent to a synthetic fiber such that an emulsifier is adhered to the synthetic fiber 8 parts by weight or less based on 100 parts by weight of a softening compound in the softening agent adhered to the synthetic fiber.

6. The process for producing a synthetic fiber according to claim 6, wherein the softening agent is an emulsion of an organopolysiloxane and the softening compound is an organopolysiloxane.

7. The process for producing a synthetic fiber according to claim 6, wherein a synthetic fiber is dipped in an aqueous solution containing the softening agent and is subjected to a treatment at 40 to 100° C. for 5 to 30 minutes such that an emulsifier is adhered to the synthetic fiber in an amount of 8 parts by weight or less based on 100 parts by weight of the softening compound in the softening agent adhered to the synthetic fiber.
